(19) United States
(12) Patent Application Publication
(10) Pub. No.: US 2013/0046601 A1
(43) Pub. Date: Feb. 21, 2013

(54) ENHANCED PRODUCT SEARCH SYSTEM AND METHOD

(71) Applicants: David Skelton, Reading (GB); Shane Ambridge, Reading (GB)

(72) Inventors: David Skelton, Reading (GB); Shane Ambridge, Reading (GB)

(73) Assignee: FROOTFUL APPS LIMITED, Reading (GB)

(21) Appl. No.: 13/211,203

(22) Filed: Aug. 16, 2011

(51) Int. Cl. G06Q 30/02

(52) U.S. Cl. 705/14.25

(57) ABSTRACT

An enhanced product search system and method are disclosed. The system comprises a search query obtaining component that obtains a search query entered by a user, and an incentive searching component that compares the search query to an incentive database containing incentives associated with goods and services and retrieves information on any incentive relating to the search query. The system also has a security component that compares the search query to a security database containing security information on the safety of websites and retrieves any security information relating to the search query. A notifying component of the system notifies the user of any incentives found by the incentive searching component and any security information found by the security component.

The invention relates to a system and method for enhancing on-line searches for products by consumers and providing an improved on-line buying experience. The system and method of the invention provide incentives when they are available, without requiring the customer to change their normal browsing and purchasing behaviour.

### BACKGROUND

On-line purchasing or e-commerce is growing at a dramatic rate particularly in the UK and the USA. There are however concerns among consumers related to on-line fraud. For instance, consumers are concerned about providing personal data to an unknown entity that may not be secure or buying fake goods.

Search technology provides a wealth of information to enable the consumer to research a product and do comparison shopping before they buy. The consumer may or may not be aware of cash back offers or rebates, coupons or other incentives related to the desired goods or services. Even if they are aware of the multiple cash back sites that offer discounts or other cash back incentives, the user must buy the goods through such a site or through browser specific add-ons. This requires the consumer to modify their on-line search and behaviour in order to attempt a cash back purchase. Consumers are frequently frustrated by going through a tedious and time consuming process at a cash back site only to learn that there is no cash back offer on the goods or services they are looking to purchase.

For the above reasons, cash back sites have not become pervasive in e-commerce. The requirement for users to modify their on-line behaviour and perform extra tasks without any guarantee that cash back will actually be provided is discouraging to many consumers.

The lengthy process that a consumer must currently go through to take advantage of a cash back offer is shown in FIG. 3. In the prior art process, consumers must log in to a separate cash back site before finding out whether cash back is actually available and must then also visit a vendor's site.

### SUMMARY OF THE INVENTION

According to an aspect of the invention, there is provided an enhanced product search system comprising: a search query obtaining component that obtains a search query entered by a user; an incentive searching component that compares the search query to an incentive database containing incentives associated with goods and services and retrieves information on any incentive relating to the search query; a security component that compares the search query to a security database containing security information on the safety of websites and retrieves any security information relating to the search query; and a notifying component that notifies the user of any incentives found by the incentive searching component and any security information found by the security component.

By combining the incentive searching component with the security component, the invention provides the advantage that a consumer can confidently take advantage of incentives such as cash back while shopping on-line without needing to worry about the safety or otherwise of websites they are visiting. Since the invention notifies the user of incentives automatically via the notifying component, the user does not need to perform any additional tasks in order to find incentives. Furthermore, since the invention notifies the user about any security issues relating to the user's search query, the user can be sure that they will not visit unsafe sites while searching for a product.

Using the present invention, the customer does not need to change their current browsing or on-line shopping behaviour and can use all common and standard browsing and search techniques. The invention enhances this secure experience by suggesting cash back offers or other incentives, but only when a known incentive is available.

Suitably, the incentives are cash back offers.

In one embodiment, the search query is the content of a link selected by the user.

Preferably, the security database includes a list of suspicious or fraudulent websites. More preferably, if the security component determines that the search query matches the address of a suspicious or fraudulent website in the security database then the notifying component presents a warning to the user. Suitably, if the security component determines that the search query matches the address of a suspicious or fraudulent website in the security database then the system prevents the user from visiting that website.

Conveniently, the security database includes a list of safe websites. Preferably, if the security component determines that the search query matches the address of a safe website in the security database then the notifying component presents a safety notification to the user.

Preferably, the incentive database and the security database are external databases outside the enhanced product search system, and are connected to the enhanced product search system over a network.

In one embodiment, the system further comprises: a research component that compares the search query to a research database containing product information and retrieves any product information relating to the search query, wherein the notifying component notifies the user of any product information retrieved by the research component along with the incentive information and the security information. Suitably, the product information is one or more of technical specifications, product reviews and product price comparison information.

According to this embodiment, the invention may also enhance the user experience by providing other information such as a price comparison.

Preferably, the research database is an external database outside the enhanced product search system, and is connected to the enhanced product search system over a network.

Suitably, the system forms part of an application that runs on a connected device, and the search query is input by the user into the application.

Preferably, the system operates entirely independently of any web browser. By being entirely independent of a browser, the system will not share any security flaws present in the browser. Hence, the security of the user's shopping experience is enhanced.

Suitably, the system forms part of an application that runs on a connected device, and the search query obtaining component obtains a search query input by the user in a separate web browser.

Conveniently, the system further comprises: an incentive emailing component that emails incentives contained in the incentive database to the user. Preferably, the incentive emailing component only operates if the user has previously input a request for incentive emails into the system. In this way, the system remains non-intrusive and does not send any unwanted emails.

Suitably, the incentive emailing component selects incentives to be emailed to the user based on the incentives selected by the user in the past.

Preferably, the system further comprises: a registration component that registers the user. More preferably, the registration component creates a user account, prompts the user to enter all of the necessary information to qualify the user for one or more incentives in the incentive database, and stores the necessary information in association with the user account.

Conveniently, the notifying component prompts the user to select an incentive that the notifying component has notified to the user, the system further comprising: an incentive registration component that obtains the selection of an incentive from the user and automatically registers the user for the selected incentive based on the necessary information. According to this embodiment, the user does not need to manually register for the incentive, which makes the process of obtaining the incentive much less time-consuming for the user. Only one central registration process using the registration component is required.

Another aspect of the invention provides a connected device comprising the enhanced product search system described above. Preferably, the connected device is one of a personal computer, a laptop, a mobile phone, a tablet device, PTV, a smartphone, an interactive device, a set-top box and a kiosk.

A further aspect of the invention provides a web browser comprising the enhanced product search system described above.

According to another aspect of the invention, there is provided a method for providing an enhanced product search comprising: obtaining a search query entered by a user; comparing the search query to an incentive database containing incentives associated with goods and services; retrieving incentive information on any incentive relating to the search query from the incentive database; comparing the search query to a security database containing security information on the safety of websites; retrieving any security information relating to the search query from the security database; and notifying the user of any incentive information and security information retrieved.

The method of the invention provides the same advantages as the system described above.

Preferably, the method further comprises: comparing the search query to a research database containing product information; and retrieving any product information relating to the search query, wherein the notifying step includes notifying the user of any product information retrieved by the research component along with the incentive information and the security information.

Suitably, the method further comprises: registering the user before the step of obtaining a search query. Preferably, the registering step comprises: creating a user account; prompting the user to enter all of the necessary information to qualify the user for one or more incentives in the incentive database; and storing the necessary information in association with the user account.

Preferably, the method further comprises: prompting the user to select an incentive notified to the user in the notifying step; obtaining the selection of an incentive from the user; and automatically registering the user for the selected incentive based on the necessary information. More preferably, the user is automatically registered for the selected incentive such that the incentive is given to an application provider rather than to the user, the method further comprising: the application provider receiving the incentive; and the application provider transferring at least a part of the value of the incentive to the user based on payment information stored in association with the user account.

This method further improves security because the user's payment information only needs to be known to the trusted application provider.

### BRIEF DESCRIPTION OF THE DRAWINGS

Embodiments of the present invention will now be described by way of further example only and with reference to the accompanying drawings, in which:

FIG. 1 is a schematic diagram showing an application according to an embodiment of the invention;

FIG. 2 illustrates a user process for a user to obtain cash back using an embodiment of the invention;

FIG. 3 illustrates a prior art process for a user to obtain cash back;

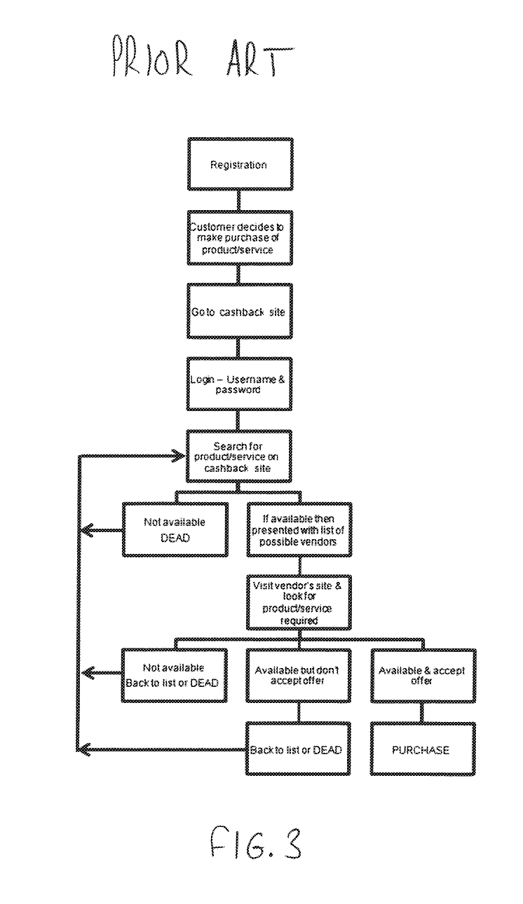

FIG. 4 is a flow diagram showing the steps performed by an embodiment of the invention; and

FIG. 5 is a schematic diagram of specific hardware according to an embodiment of the invention.

### DETAILED DESCRIPTION

Embodiments of the present invention include methods and systems for providing a secure shopping experience enhanced by one or more incentives to a user. The invention operates in a non-intrusive manner as it only notifies a user when a real incentive has been identified or an enhanced user experience can be provided.

The term “incentive” will be used in the following description to refer to the offers detected by the system of the invention and notified to the user. It should be appreciated that the invention is not limited to providing cash back offers or any other particular kind of offer, and any form of incentive to the user may be provided. These include rebates and coupons for example.

A first embodiment of the invention operates in a normal browser based environment, in which a user browses the web on a connected device in a conventional way using their preferred browser and search products. A “connected device” is defined as any computerised product that has internet or other on-line connectivity. This includes, but is not limited to, personal computers, laptop computers, mobile phones, tablet devices, IPTV, smartphones, interactive devices, set-top boxes and kiosks.

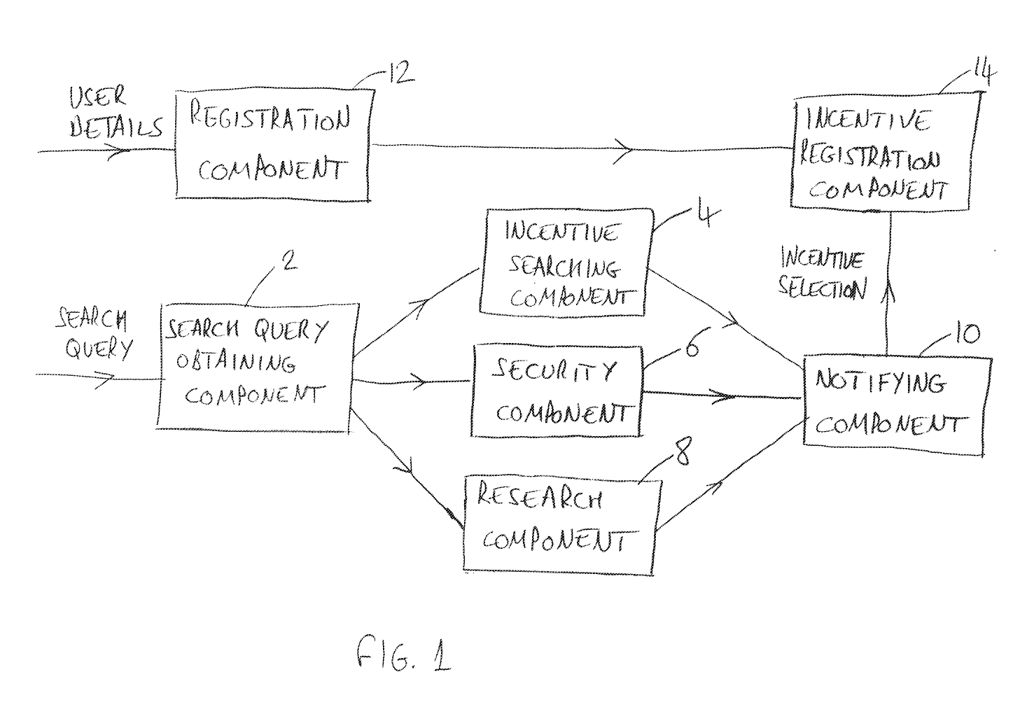

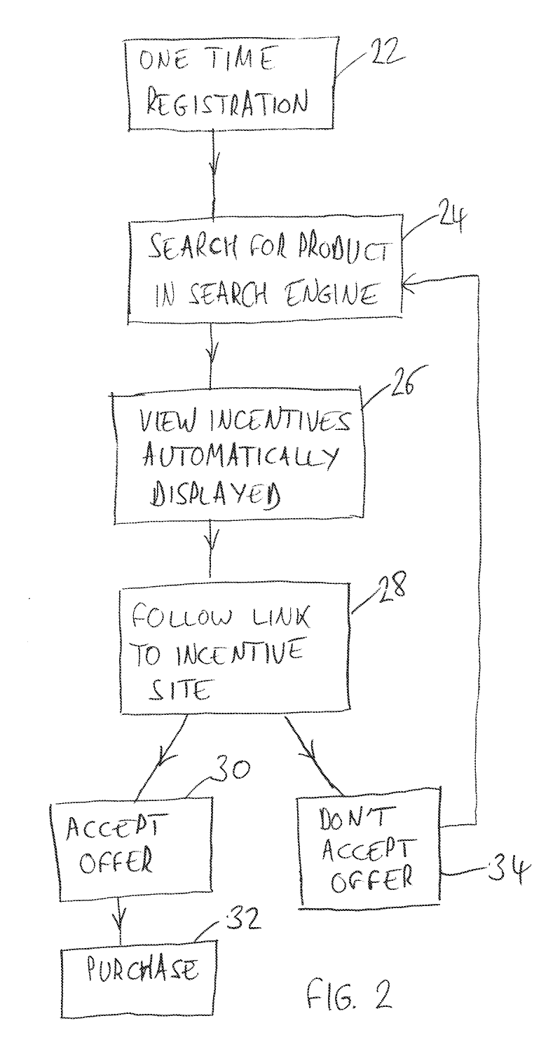

In this embodiment, the invention takes the form of an application that resides in the memory of the connected device. The application runs in the background on the connected device and is normally invisible to the user, with the possible exception of an indicator that the application is running being provided in a system tray or the like. A schematic diagram of components included in the application is shown in FIG. 1. The process that a user performs to take advantage of an incentive using an application according to the present invention is shown in FIG. 2.

When the application is first installed on the connected device, the user is prompted to register with the application provider at step 22 in FIG. 2. This process is handled by the registration component 12 shown in FIG. 1, which prompts the user to enter the necessary personal details and stores them in association with a user account. This registration process is secure and gives the application provider all the necessary details of the user to register the user for cash back offers and other incentives provided by third parties.

In the course of browsing and/or searching the web, the user will enter a search query into a search engine or mobile application, shown as step 24 in FIG. 2. The application wakes up when it detects that a user has entered a search query using any browser or search engine on the connected device. The application includes a search query obtaining component 2 that obtains the search query entered by the user.

According to this embodiment, the application compares search terms making up the search query to a number of databases. The application compares the search query to at least the following two types of database:
An incentive database containing details of incentives such as cash back and rebate offers corresponding to particular brands and products. Such databases are typically provided by third party companies, known as affiliate or merchant networks. These third parties are preferably authorised partners of the brand or product owners.
A security database, which may contain a list of suspicious or known fraudulent or unauthorised websites. Additionally or alternatively, the security database may include a list of known safe and authorised websites.

The application includes an incentive searching component 4 that compares the obtained search query to the incentive database and retrieves information on any incentive relating to the search query. If an incentive associated with the search query is found in the incentive database then a notifying component 10 is activated. The notifying component 10 provides information to the user about the incentives associated with the brand or product identified in the database. The user can then view the incentives displayed by the notifying component 10 at step 26 in FIG. 2.

In this embodiment, the notifying component 10 creates a new window over part of the screen of the connected device. However, it will be appreciated that the notifying component 10 may also provide the information to the user using a different presentation method, particularly when the invention is applied to a smaller screen, a window environment or another type of interactive interface device.

If several incentives in the form of cash back offers associated with the search query are found then the notifying component 10 presents them in the order of cheapest offer first.

The new window contains information on the incentive(s) and also contains one or more links that the user can click on to take advantage of a selected incentive. Clicking on the link navigates the user directly to the incentive website and also automatically qualifies the user for the incentive without the user needing to perform any additional log in or registration process. This step is shown as step 28 in FIG. 2.

Since the user has already provided all of the necessary information to register for the incentive during the initial registration process 22 on installing the application, there is no need for the user to perform further registration processes. The details of the user stored by the registration component 12 are passed to an incentive registration component 14, which then uses the details to register the user for the selected incentive automatically.

The application can provide all of the necessary information to the third party providing the incentive automatically from the application provider's database, without the user being directly involved. This is a significant advantage of the invention as it makes the process of obtaining incentives such as cash back much more straightforward for the user.

As illustrated by steps 30 and 34 in FIG. 2, once the user has followed a link to an incentive, the user can either accept or reject the offer made by the incentive provider. If the user accepts the offer then a purchase is made at step 32 and the incentive is awarded to the user. Typically, the application provider will receive a percentage of the value of the incentive as commission for the sale.

In one embodiment, the application passes information to the incentive provider enabling the incentive provider to award the incentive to the application provider rather than to the user when the user follows the link to the incentive at step 28. In this embodiment, the application provider then passes on the majority of the value of the incentive to the user using the information provided by the user in the initial registration step 22. The remainder of the incentive is kept by the application provider as commission. This embodiment is particularly secure as the user only needs to give his payment details to the application provider rather than to multiple unknown incentive providers.

Alternatively, the incentive may be provided directly to the user by the incentive provider based on information passed to the incentive provider by the application at step 28. The application provider can then claim commission separately from the incentive provider.

If the user rejects the incentive provider's offer at step 34 then the user is free to begin searching again at step 24.

The application contains a security component 6, which compares the search query to a security database containing security information on the safety of websites. The security database includes a list of websites that are suspicious or known to be fraudulent in this embodiment. If the search query matches information relating to fraudulent or suspicious websites contained in the security database, the notifying component 10 will provide an appropriate warning message. In the particular embodiment described above, the notifying component 10 may create a new window containing the warning message. However, it will be appreciated that the warning may be conveyed to the user in various other ways, for example by illuminating an indicator forming part of the browser window or changing the colour of text forming the search query entered by the user.

The security database may include a separate list of websites that are known to be safe and the notifying component 10 may also notify the user if the search query matches information on safe websites contained in the security database. This may be done additionally or alternatively to the process of matching information relating to fraudulent or suspicious websites. In one example, the notifying component 10 provides a safe indicator such as a green light to the user if the search query corresponds to a safe website. On the other hand, the notifying component 10 provides an unsafe indicator such as a red light to the user if the search query corresponds to a fraudulent or suspicious website.

The search query may also be compared to other databases by other components of the application. In this embodiment, the application includes a research component 8 that compares the search query to a research database containing product specifications and other information about specific products.

If the search query matches a product in the research database for which further information is available then the notifying component 10 will provide a message indicating its availability. For example, the further information may include technical specifications of the product, a list of alternative similar products, reviews of the product or a price comparison between different vendors of the product.

The message indicating the availability of further information may be notified to the user in any of the ways described above in relation to the security and incentive databases. In one embodiment, the notifying component 10 creates a new window containing the message and a link that the user can click on to access the further information. Alternatively, an indicator may be displayed to the user and the user may access the further information by hovering a cursor over the indicator.

The application of the invention may also include an incentive emailing component that emails information on incentives contained in the incentive database to the user. The incentives emailed to the user may be chosen based on information provided by the user during the initial registration 22, or may be selected based on incentives that have been taken by the user in the past. Importantly, the application only emails incentives to the user if the user has actively opted in to receive them, either during registration or via the application at a later time. As a result, the application remains non-intrusive and does not send unwanted emails to users.

The embodiment described above allows the user to browse the web as usual without changing their search behaviour and without having to shop via a cash back site. The notifying component 10 only provides additional and relevant information when a brand or product having a listed incentive or further information available is identified, or if the user types in a search query corresponding to a website address contained in the security database.

The user can either ignore the information provided by the notifying component 10 and proceed as normal, or the user can click on a link provided by the notifying component 10 and thereby take advantage of the incentive or further information offered. The user is also made aware when a website they are searching for is known to be safe or suspected of being unsafe by the notifying component 10. As a result, the user can shop/purchase with confidence on safe websites and can avoid unsafe sites or proceed with caution when using them (for example by using a safer payment method).

In a non-browser environment, for instance a mobile or smartphone device, the invention preferably takes the form of a custom shopping application with a built in product search capability. The application features the search query obtaining component 2 and the notifying component 10 described above. The search query obtaining component 2 differs in that the search query is entered directly into the application by the user and is then picked up by the search query obtaining component 2, rather than being entered into a search engine via a separate browser. In the same way as described above, if the search query matches a brand or product contained in the incentive database, or matches a suspicious or safe website in the security database, the notifying component 10 will display incentives or warnings relating to the search query.

In the non-browser environment, the notifying component 10 will not generally create a new window to display incentives or warnings to the user. Instead, these messages will be displayed by the notifying component 10 as part of a main screen of the custom shopping application. The user can select incentives presented by the notifying component 10 in the custom shopping application and the application will then automatically qualify the user for the incentive, as described above in relation to the browser based environment.

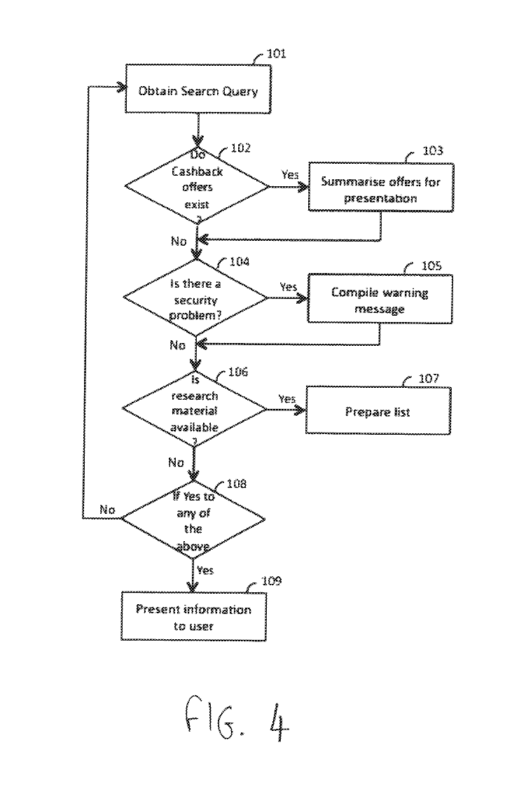

An example of the method performed by an embodiment of the invention is described in more detail below with reference to FIG. 4.

As shown in FIG. 4, in a first step 101 a search query is obtained. This step may be performed by capturing text input by a user into a search bar in a browser window or mobile application for example. Alternatively, the search query may be obtained by detecting that the user is controlling a cursor to hover over a URL link in a browser or other software application. The URL link is then taken as the search query.

As described above, the obtained search query is then used to determine if one or more incentives exist for brands or products associated with the search query. This is step 102 shown in FIG. 4. The step is performed by interrogating one or more incentive databases containing cash back and/or other incentives. Typically, the incentive databases are external databases from global affiliate and merchant networks. However, it will be appreciated that one or more databases internal to the system of the invention may also be used. If any incentives do exist then this information is sent back to the system of the invention by the external databases.

Once it has been determined that incentives exist in step 102, the system summarises the incentives for presentation at step 103. The summarisation process takes data from the database and formats it for presentation in the appropriate format for the connected device being used. The system will present incentives in different formats for different devices. In one example, the incentives are presented in a layered structure, which enables the user to drill though several layers of information.

If the search query is a URL or website address, a step 104 of determining whether there is a security problem is performed. This step includes comparing the search query to a security database and determining whether the search query matches any known suspicious (or safe) websites contained in the security database. The comparison process allows the system to determine whether there is any risk for the user in visiting the website associated with the search query.

If the search query does match a suspicious website in the security database, a step 105 of compiling a warning message is performed. This step involves determining the type of risk presented to the user based on information about the suspicious website contained in the security database and preparing an appropriate message for display to the user. This process will also prevent navigation to the site until the warning message is displayed on the connected device screen, so that the user cannot visit the suspicious website without knowing the risk involved.

If the search query is found to match the address of a known safe website in the security database in step 104 then the system may perform a step of notifying the user that the website can be trusted. As in the case of a suspicious website, the system prepares an appropriate message for display based on information about the safe website in the security database.

Following the security check, the system performs a step 106 of determining whether research material relating to the search query is available. If the search is a product then the system interrogates one or more research databases containing product information such as technical specifications. Research databases that may be interrogated using the search query in this step include the product manufacturer's database, affiliate databases, review databases and price comparison shopping databases. If step 106 finds that relevant research material is available, a step 107 of compiling a list of research information available is performed.

If any of the steps 102, 104 and 106 described above deliver a positive result, a step 109 of presenting the information prepared for display in steps 103, 105 and 107 is performed. Step 109 is performed by the notifying component 10 described above so as to display the retrieved information on the connected device.

The invention can operate with any browser type or custom application on any connected device. Furthermore, the invention can operate on devices independent of or without browser support.

It will be appreciated that the components of the embodiments described above may be implemented either in hardware or in software, or in a combination of both. Furthermore, each component may be provided within a browser environment on the connected device or may form part of an application running on the connected device that is separate from any browser. When a separate application is provided, this application may either interact with a browser operating at the same time or operate independently of a browser.

By providing an application according to the invention that is completely independent of any browser, the security of the system can be enhanced. Since the application does not exchange information with a browser in this embodiment, security flaws in the browser software will not affect the application. In particular, when the invention is implemented in a mobile phone or smartphone, the components of the invention are preferably provided in a stand alone application independent of any browser.

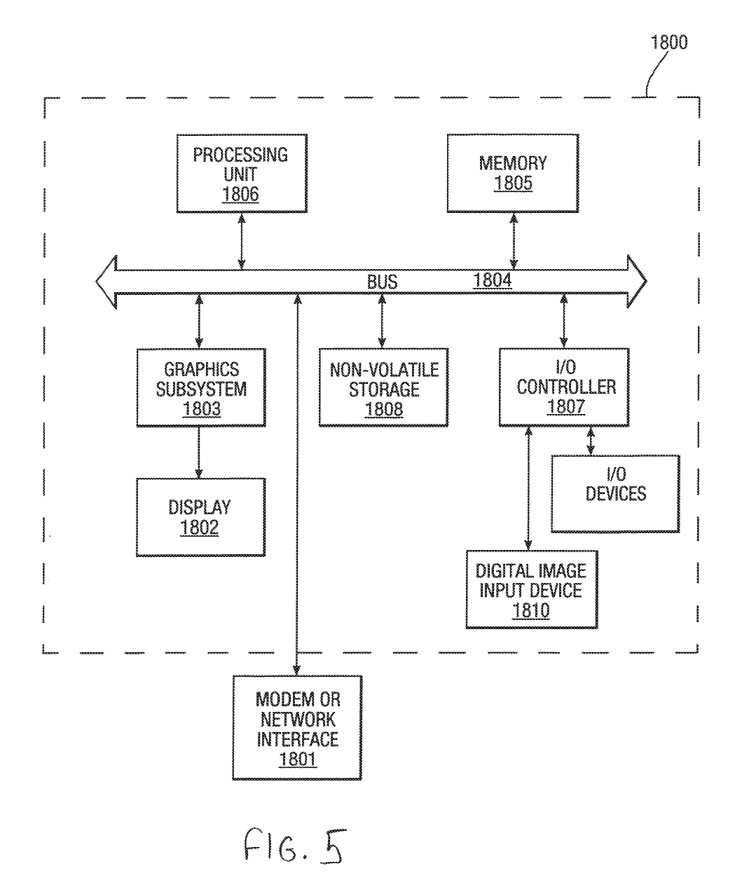

FIG. 5 illustrates an exemplary embodiment of a connected device 1800 in which the system and method of the present invention may be realised.

The connected device 1800 may interface to external systems through a fixed wire or wireless connection or any other network interface 1801 such as analog or ISDN modems, cable modems (ADSL/DSL), Ethernet or fibre optic interfaces, cellular or HSDS services and satellite transmission interfaces. As shown in FIG. 5 the connected device 1800 includes a processing unit 1806, which may be a conventional microprocessor, such as an Intel Core microprocessor or an ARM Cortex microprocessor, which are known to one of ordinary skill in the computer art.

System memory 1805 is coupled to the processing unit 1806 by a system bus 1804. System memory 1805 may be a DRAM, RAM, static RAM (SRAM) or any combination thereof. Bus 1804 couples processing unit 1806 to system memory 1805, to non-volatile storage 1808, to graphics subsystem 1803 and to input/output (I/O) controller 1807. Graphics subsystem 1803 controls a display device 1802, for example a liquid crystal display, which may be part of the graphics subsystem 1803. The I/O devices may include one or more of a keyboard, tablet, stylus, disk drives, printers, a mouse, a touch screen or other gesture driven interface and the like as known to one of ordinary skill in the computer art.

A digital image input device 1810 may be a scanner or a digital camera, which is coupled to I/O controller 1807. The non-volatile storage 1808 may be a magnetic hard disk, a flash memory or another form of storage for large amounts of data. Some of this data is often written by a direct memory access process into the system memory 1805 during execution of the software in the computer system 1800.

The foregoing description has been given by way of example only and it will be appreciated by a person skilled in the art that modifications can be made without departing from the scope of the present invention.

What is claimed is:

1. An enhanced product search system comprising:
a search query obtaining component that obtains a search query entered by a user;
an incentive searching component that compares the search query to an incentive database containing incentives associated with goods and services and retrieves information on any incentive relating to the search query;
a security component that compares the search query to a security database containing security information on the safety of websites and retrieves any security information relating to the search query; and
a notifying component that notifies the user of any incentives found by the incentive searching component and any security information found by the security component.

2. An enhanced product search system according to claim 1, wherein the incentives are cash back offers.

3. An enhanced product search system according to claim 1, wherein the search query is the content of a link selected by the user.

4. An enhanced product search system according to claim 1, wherein the security database includes a list of suspicious or fraudulent websites.

5. An enhanced product search system according to claim 4, wherein if the security component determines that the search query matches the address of a suspicious or fraudulent website in the security database then the notifying component presents a warning to the user.

6. An enhanced product search system according to claim 5, wherein if the security component determines that the search query matches the address of a suspicious or fraudulent website in the security database then the system prevents the user from visiting that website.

7. An enhanced product search system according to claim 1, wherein the security database includes a list of safe websites.

8. An enhanced product search system according to claim 7, wherein if the security component determines that the search query matches the address of a safe website in the security database then the notifying component presents a safety notification to the user.

9. An enhanced product search system according to claim 1, wherein the incentive database and the security database are external databases outside the enhanced product search system, and are connected to the enhanced product search system over a network.

10. An enhanced product search system according to claim 1, further comprising:
a research component that compares the search query to a research database containing product information and retrieves any product information relating to the search query,
wherein the notifying component notifies the user of any product information retrieved by the research component along with the incentive information and the security information.

11. An enhanced product search system according to claim 10, wherein the product information is one or more of technical specifications, product reviews and product price comparison information.

12. An enhanced product search system according to claim 10, wherein the research database is an external database outside the enhanced product search system, and is connected to the enhanced product search system over a network.

13. An enhanced product search system according to claim 1, wherein the system forms part of an application that runs on a connected device, and the search query is input by the user into the application.

14. An enhanced product search system according to claim 13, wherein the system operates entirely independently of any web browser.

15. An enhanced product search system according to claim 1, wherein the system forms part of an application that runs on a connected device, and the search query obtaining component obtains a search query input by the user in a separate web browser.

16. An enhanced product search system according to claim 1, further comprising:
an incentive emailing component that emails incentives contained in the incentive database to the user.

17. An enhanced product search system according to claim 16, wherein the incentive emailing component only operates if the user has previously input a request for incentive emails into the system.

18. An enhanced product search system according to claim 16, wherein the incentive emailing component selects incentives to be emailed to the user based on the incentives selected by the user in the past.

19. An enhanced product search system according to claim 1, further comprising:
a registration component that registers the user.

20. An enhanced product search system according to claim 19, wherein the registration component creates a user account, prompts the user to enter all of the necessary information to qualify the user for one or more incentives in the incentive database, and stores the necessary information in association with the user account.

21. An enhanced product search system according to claim 20, wherein the notifying component prompts the user to select an incentive that the notifying component has notified to the user, the system further comprising:
an incentive registration component that obtains the selection of an incentive from the user and automatically registers the user for the selected incentive based on the necessary information.

22. A connected device comprising the enhanced product search system according to claim 1.

23. A connected device according to claim 22, wherein the connected device is one of a personal computer, a laptop, a mobile phone, a tablet device, IPTV, a smartphone, an interactive device, a set-top box and a kiosk.

24. A web browser comprising the enhanced product search system according to claim 1.

25. A method for providing an enhanced product search comprising:
obtaining a search query entered by a user;
comparing the search query to an incentive database containing incentives associated with goods and services;
retrieving incentive information on any incentive relating to the search query from the incentive database;
comparing the search query to a security database containing security information on the safety of websites;
retrieving any security information relating to the search query from the security database; and
notifying the user of any incentive information and security information retrieved.

26. A method according to claim 25, further comprising:
comparing the search query to a research database containing product information; and
retrieving any product information relating to the search query,
wherein the notifying step includes notifying the user of any product information retrieved by the research component along with the incentive information and the security information.

27. A method according to claim 25, further comprising:
registering the user before the step of obtaining a search query.

28. A method according to claim 27, wherein the registering step comprises:
creating a user account;
prompting the user to enter all of the necessary information to qualify the user for one or more incentives in the incentive database; and
storing the necessary information in association with the user account.

29. A method according to claim 28, further comprising:
prompting the user to select an incentive notified to the user in the notifying step;
obtaining the selection of an incentive from the user; and
automatically registering the user for the selected incentive based on the necessary information.

30. A method according to claim 29, wherein the user is automatically registered for the selected incentive such that the incentive is given to an application provider rather than to the user, the method further comprising:
the application provider receiving the incentive; and
the application provider transferring at least a part of the value of the incentive to the user based on payment information stored in association with the user account.
